(19) United States
(12) Patent Application Publication
(10) Pub. No.: US 2018/0197417 A1
(43) Pub. Date: Jul. 12, 2018

(54) TRAILER MODE BLIND SPOT SENSOR

(71) Applicant: Continental Automotive Systems, Inc., Auburn Hills, MI (US)

(72) Inventors: Joseph Burtch, Lake Orion, MI (US); James H. Critchley, Lake Orion, MI (US)

(73) Assignee: Continental Automotive Systems, Inc., Auburn Hills, MI (US)

(21) Appl. No.: 15/868,409

(22) Filed: Jan. 11, 2018

Related U.S. Application Data
(60) Provisional application No. 62/445,192, filed on Jan. 11, 2017.

(51) Int. Cl. G08G 1/16; B60R 1/06; B60R 1/12; B60R 1/08

(52) U.S. Cl. CPC G08G 1/167; B60R 1/0612; B60W 30/09; B60R 1/081; B60R 1/12

(57) ABSTRACT

A sensing system of a vehicle includes a rear view mirror coupled to a body of the vehicle and movable between a first position and a second position. The system also includes a proximity sensor coupled to the vehicle. The proximity sensor is obscured by the mirror in the first position.

### CROSS REFERENCE TO RELATED APPLICATION

This application claims the benefit of provisional patent application No. 62/556,192, filed Jan. 11, 2017, which is hereby incorporated by reference.

### TECHNICAL FIELD

The technical field relates generally to a blind spot sensor for a vehicle and more specifically to a blind spot sensor for a vehicle with a trailer attached.

### BACKGROUND

Vehicles are increasingly being fitted with proximity sensors utilized to determine the presence of objects (e.g., vehicles), in blind spots, i.e., the locations around a vehicle which are not easily visable to a driver of the vehicle via the rear-view mirrors of the vehicle. Such “blind spot detection” is even more critical when a trailer is coupled to the vehicle, thus often increasing and/or changing the area of the blind spot.

As such, it is desirable to present a sensing system for sensing objects in a blind spot of a vehicle. In addition, other desirable features and characteristics will become apparent from the subsequent summary and detailed description, and the appended claims, taken in conjunction with the accompanying drawings and this background.

### BRIEF SUMMARY

In one exemplary embodiment, a sensing system of a vehicle includes a rear view mirror coupled to a body of the vehicle and movable between a first position and a second position. The system also includes a proximity sensor coupled to the vehicle. The proximity sensor is obscured by the mirror in the first position.

In one exemplary embodiment, a method of operating a sensing system includes moving the rear view mirror to the second position in response to a trailer being connected to the vehicle. The method also includes sensing objects in a blind spot of the vehicle with the proximity sensor in response to the rear view mirror being in the second position.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a view of a rear view mirror assembly showing a rear view mirror movable between positions; and

FIG. 2 is a block diagram of the vehicle showing a sensing system 200 and a plurality of rear view mirror assemblies.

### DETAILED DESCRIPTION

Referring to the Figures, wherein like numerals indicate like parts throughout the several views, a rear view mirror assembly 100 is shown and described herein. The rear view mirror assembly 100 may be part of a sensing system 200 for a vehicle 202.

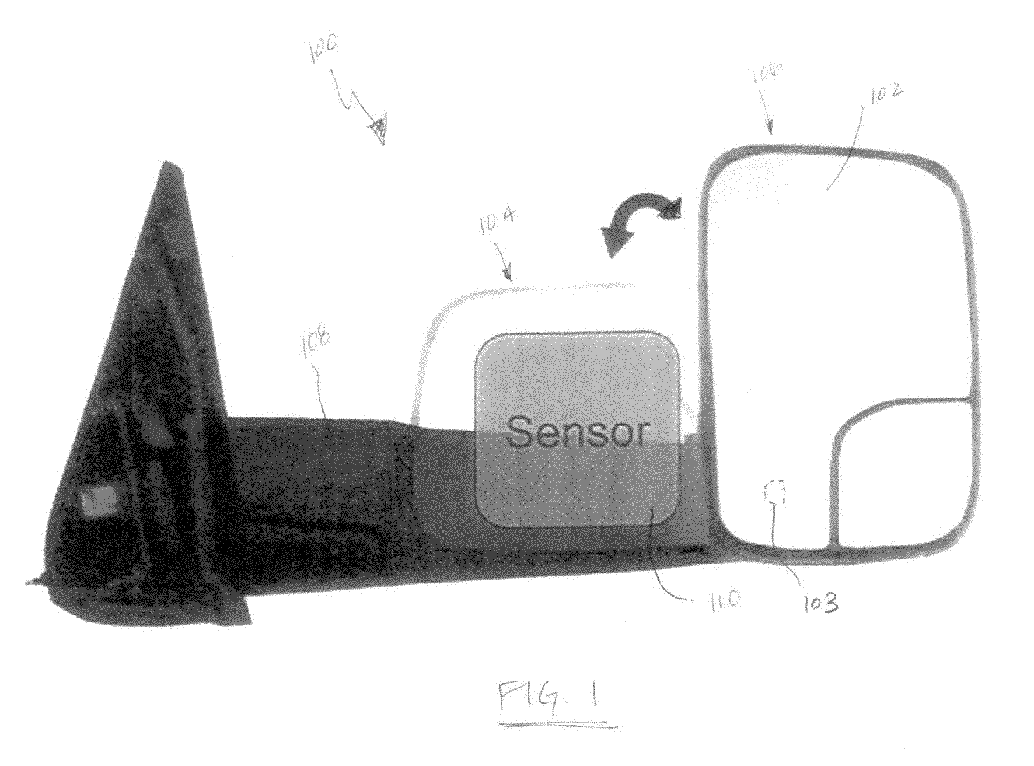

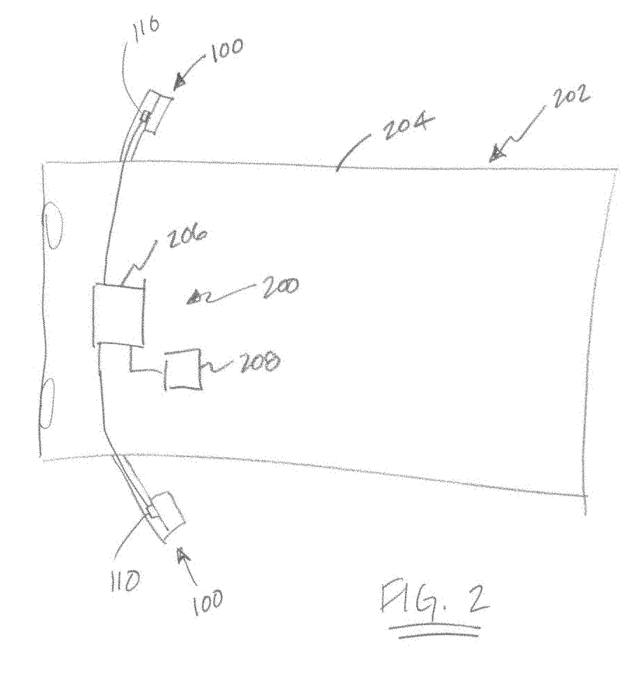

Referring to FIGS. 1 and 2, the rear view mirror assembly 100 includes a rear view mirror 102. The rear view mirror 102 is coupled to a body 204 of the vehicle 202. Referring The rear view mirror 102 may include one or more reflecting surfaces (not numbered) as appreciated by those skilled in the art.

The rear view mirror is movable between a first position 104 and a second position 106. More particularly, in the exemplary embodiment shown in FIG. 1, the rear view mirror 102 is pivotable about an axis 103. A motor (not shown) may be utilized to actuate movement of the rear view mirror 102 between the first and second positions 104, 106.

Typically, the rear view mirror 102 is situated in the first position 104 during normal operation, when a trailer (not shown) is not being towed. However, while the vehicle 202 is towing a trailer, the rear view mirror 102 may be situated in the second position 106, which in this embodiment, is generally situated farther away from the body of the vehicle. Situating the rear view mirror 102 in the second position 106 assists in allowing a driver of the vehicle 202 to see behind the trailer.

In the exemplary embodiment, the rear view mirror assembly 100 includes an arm 108 coupling the rear view mirror 102 to the body of the vehicle.

The assembly 100 also includes a proximity sensor 110 coupled to the vehicle 202. In the exemplary embodiment, the proximity sensor 110 is coupled to the arm 108. The proximity sensor 110 may be utilized to detect the presence of an object (e.g., another vehicle) in a blind-spot of the vehicle 202.

As stated above, the blind-spot of a vehicle-trailer combination may be larger and/or have different dimensions than the blind-spot of the vehicle 202 without the trailer. In the exemplary embodiment, the proximity sensor 110 is only utilized to detect the presence of an object in the blind-spot of the vehicle-trailer combination. Thus, the proximity sensor 110 is not used when the vehicle 202 is not towing the trailer.

In the exemplary embodiment, the proximity sensor 110 is obscured by the mirror 102 when the mirror 102 is in the first position 104. The term “obscured” as used herein, should be appreciated to mean that the proximity sensor 110 is not readily visible when the mirror 102 is in the first position 104. Therefore, the proximity sensor 110 may be hidden when there is no trailer connected to the vehicle 202. As such, the proximity sensor 110 does not take up any additional area on the assembly 100. Furthermore, in one exemplary embodiment, the proximity sensor 110 may not function when the mirror 102 is in the first position 104, as a field of view of the proximity sensor 110 may be blocked by the mirror 102. Conversely, in the second position 106, the proximity sensor 110 may be visible and is functional.

Of course, the sensing system 200 may include a plurality of proximity sensors 110, e.g., one associated with a first side (not numbered) of the vehicle 202 and another associated with a second side (not numbered) of the vehicle 202, as shown in FIG. 2. The sensing system 200 may also include a processor 206 in communication with the proximity sensors 110. The processor 206 is a computational device able to perform calculations and/or execute instructions (i.e., run a program). The processor 206 may be implemented with a microprocessor, microcontroller, application specific integrated circuit (“ASIC”) or other suitable device or devices as appreciated by those skilled in the art. The processor 206 is configured to receive signals and/or data from the proximity sensors 110 regarding whether or not an object is in the blind-spot of the vehicle-trailer combination.

The sensing system 200 may also include an annunciator 208 in communication with the processor 206. The annunciator 208, e.g., a human-machine interface, may be implemented with at least one of a display, a speaker, a light, or any other suitable device for conveying information. In the exemplary embodiment, the annunciator 208 receives signals and/or data from the processor 206 regarding the presence of an object in the blind-spot of the vehicle-trailer combination.

The sensing system 200 may also be in communication with an autonomous driving system (not shown) or similar-type system for controlling operation of the vehicle 202. As such, the sensing system 200 may provide information regarding objects in the blind-spot of the vehicle-trailer combination, such that the autonomous driving system may make changes to a driving path, change direction, change speed, brake the vehicle 202, and/or make other suitable adjustments or emergency maneuvers.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A sensing system of a vehicle, comprising:
a rear view mirror coupled to a body of the vehicle and movable between a first position and a second position; and
a proximity sensor coupled to the vehicle;
wherein said proximity sensor is obscured by said mirror in said first position.

2. The system as set forth in claim 1, wherein said rear view mirror is pivotable about an axis.

3. The system as set forth in claim 1, further comprising an arm coupling said rear view mirror to the body of the vehicle.

4. The system as set forth in claim 3, wherein said proximity sensor is coupled to said arm.

5. The system as set forth in claim 1, wherein said proximity sensor is configured to detect objects in a blind spot of the vehicle.

6. The system as set forth in claim 5, further comprising a processor in communication with said proximity sensor for receiving data regarding the presence of an object in the blind spot of the vehicle.

7. The system as set forth in claim 6, further comprising an annunciator in communication with said processor to alert a driver of the vehicle as to the presence of an object in the blind spot of the vehicle.

8. The system as set forth in claim 1, where said proximity sensor is configured to detect objects in a blind spot of the vehicle only when a trailer is connected to the vehicle.

9. The system as set forth in claim 1, wherein said proximity sensor is configured to detect objects in a blind spot of the vehicle when said rear view mirror is in said second position.

10. The system as set forth in claim 1, where said proximity sensor is configured to detect objects in a blind spot of the vehicle only when a trailer is connected to the vehicle and said rear view mirror is in said second position.

11. A method of operating a sensing system of a vehicle, the vehicle including a rear view mirror coupled to the body of the vehicle and movable between a first position and a second position, and a proximity sensor coupled to the vehicle, the proximity sensor obscured by said mirror in the first position, said method comprising:
moving the rear view mirror to the second position in response to a trailer being connected to the vehicle; and
sensing objects in a blind spot of the vehicle with the proximity sensor in response to the rear view mirror being in the second position.

12. The method as set forth in claim 12, further comprising alerting a driver of the vehicle as to the presence of an object in the blind spot of the vehicle with an annunciator in response to an object being sensed by the proximity sensor.
